(19) United States
(12) Patent Application Publication
(10) Pub. No.: US 2009/0090273 A1
(43) Pub. Date: Apr. 9, 2009

(54) Silver Organo-Sol Ink for Forming Electrically Conductive Patterns

(75) Inventors: Soon Yeong Heo, Daegu (KR); Dong Sung Seo, Daejun (KR); Eun Ji Lee, Daegu (KR); Seung Jun Han, Kyungsangnam-do (KR); Kwang Seop Kim, Seoul (KR); Hyun Myung Jang, Kyungsangbuk-do (KR)

Correspondence Address: MCDERMOTT WILL & EMERY LLP, 28 STATE STREET, BOSTON, MA, 02109-1775, US

(73) Assignee: EXAX INC,, KYUNGSANG-BUK-DO (KR)

(21) Appl. No.: 12/278,898

(22) PCT Filed: Jan. 11, 2007
(86) PCT No.: PCT/KR2007/000206

§ 371 Date: Aug. 8, 2008

(30) Foreign Application Priority Data
Feb. 13, 2006 (KR) 10-2006-0013535

(51) Int. Cl. C09D 11/02

(52) U.S. Cl. 106/31.92

(57) ABSTRACT

The present invention relates to solution type silver organo-sol ink for forming electrically conductive patterns. The present invention provides silver organo-sol ink of solution type for forming electrically conductive pattern comprising effective amount of silver CO to C16 aliphatic carboxylate saturated or unsaturated, linear or branched, unsubstituted or substituted with amino, nitro and/or hydroxy group(s) having 1 to 3 carboxyl groups or silver aromatic carboxylate; and organic solvent. By the present invention, silver organo-sol inks of solution type basically having higher content of silver for various reducing or metallizing temperatures are obtained. The solution type ink of the present invention can be used for forming conductive patterns in flat panel display such as plasma display panel(PDP) to reduce the numbers of steps for pattern forming. Some of the solution type ink of the present invention can be used for forming conductive patterns on a milder substrate such as thermoset plastic at a lower reducing temperature.

### TECHNICAL FIELD

The present invention relates to silver organo-sol ink, more specifically ink containing a silver precursor for forming electrically conductive patterns.

### BACKGROUND ART

In semiconductor and display industries, pattern forming technologies are classified into 3 categories. One is a subtractive method mainly applied to thin film technologies such as CVD, PVD and sputtering wherein a functional layer is deposited on a substrate, a photo-resist layer is patterned by lithography on the functional layer, and then the functional layer is etched into a pattern. Another is an additive method used in thick film technologies such as screen-printing. The other is a subtractive-additive method adopting both of a subtractive method and an additive method. Pattern forming by an additive method is an economical process, which spares material and reduces number of steps, but additive methods of thick filmtechnologies such as screen-printing are not so fine as thin filmtechnologies, and thus are applied to different processes.

If an additive method accomplishes finer patterns, it is more favorable in aspects of environment and cost reduction. In this context, pattern forming by inkjet printing has been recently noted. For example, attempts to apply an additive method to pattern forming for color filters originally formed by thin filmtechnologies have been made.

MOD material has been researched since Vest, R. W. tested inks made of MOD material (IEEE Transactions on Components, Hybrids and Manufacturing Technology, 12(4), 545-549, 1987). Kydd, et al in WO98-37133 disclosed inkjet-printing ink consisting of MOD material and particulate metal. U.S. Pat. No. 6,878,184 owned by Kovio Inc. disclosed metal ink of nano-size particle prepared from MOD and a reductant (for example, aldehydes). Many attempts have been made to use ink containing dispersed fine metal particles, especially silver particles for forming electrically conductive patterns. A new inkjet-printing system including nozzles should be devised with inks dispersed with fine metal particles, i.e., fine silver particles because those behave differently from ordinary inks. In addition, additives added to sustain suspension would do harm to the physical properties of patterns formed.

In the above-mentioned respect, inks containing MOD (metallo-organic decomposition material) can be applied to traditional inkjet printing devices without severe modification of the system if those are thoroughly solution. Solution inks containing MOD, in addition, can lower the temperature of metallization, and thus can be applied on flexible substrates such as plastic.

Korean Patent Publication No. 2004-85470 applied by Haeuncomtec disclosed a metal ink for inkjet-printing consisting of 5˜40 t % of silver oxide, 10-20 wt % of lactam, lactone or carbonate and 20-85 wt % of amine. The ink prepared in the example is likely suspension rather than solution considering the dark color of the ink. Emulsifier which may do harm to the physical properties of patterns formed, should be added to the ink to sustain suspension, In addition, maintenance problems concerning nozzle clog caused by particles may arise.

Prior arts published to date are listed below.

TABLE 1
Patent Documents

| | | | | Application | |
|---|---|---|---|---|---|
| | | | | Date (Publication | |
| | | | | or Registration | |
| No. | Country | Applicant (Inventor) | Title of Invention | No.) | Technical Features |
| 1) | US | Engelhard(Pascaline | metallized | 1986.09.10(Pat. No. | Metal carboxylate, |
| | | Nguyen) | substrates and | 4,808,274) | alcoholate, |
| | | | process for | | mercaptide, |
| | | | producing | | amino + carboxylate, |
| | | | | | acyl + carboxylate, |
| | | | | | alkoxide |
| 2) | US | (Michael G. | Seed layer compositions | 1990.04.27(Pat. No. | metal bonded to |
| | | Firmstone, | containing | 5,059,242) | hydrocarbon |
| | | et al) | organogold and | | through thio, |
| | | | organosilver | | polythio, |
| | | | compounds | | carboxylate bridge |
| 3) | US | Degussa | Gold(I) mercaptocarboxylic | 1993.04.05(Pat. No. | gold(I)mercaptocarboxyic |
| | | (Lotze; | acid | 5,312,480) | acid ester |
| | | Marion) | esters, method of | | used for ceramic |
| | | | their preparation | | gold decoration |
| | | | and use | | |
| 4) | PCT | Parelec, | Material and | International Application | metal |
| | | Inc. (Kydd; | method for | 1997.09.1 | powder + MOD or |
| | | Paul H. □□) | printing high conductivity | 2(international | ROM (reactive |
| | | | electrical | publication | organic medium); |
| | | | conductors and | WO98-37133) | MOD is defined as |
| | | | other components | | organic material |
| | | | on thin film | | bonded to metal |
| | | | transistor arrays | | through hetero |
| | | | | | atoms such as O, |
| | | | | | N, S, P, As and Se |
| 5) | US | Kovio, Inc | Nanoparticle | 2002.08.09(Pat. No. | particulate ink |
| | | (Rockenberger; | synthesis and the | 6,878,184) | prepared by |
| | | Joerg) | formation of inks | | reducing MOD(or |
| | | | therefrom | | metal powder + |
| | | | | | RMO) with |
| | | | | | aldehydes |
| 6) | South | haeuncomtec | Organic silver | 2003.03.28(Publication | 5-40 wt % of |
| | Korea | (Kwangchun- | composition, | No. | Ag + 10-20 wt % of |
| | | Jung) | preparing method | 2004-84570) | (lactam, lacton or |
| | | | therefor, inks | | carbonate + 20-85 wt % |
| | | | prepared | | of amine |
| | | | therefrom and | | |
| | | | method for | | |
| | | | forming | | |
| | | | conductive circuit | | |
| | | | with use thereof | | |

TABLE 2
Non-patent Documents

| | | Title | Publication | |
|---|---|---|---|---|
| No. | author | of Article | date | Technical features |
| 1) | Teng, K. F., | Liquid Ink | IEEE | MOD is mentioned as organic |
| | and | Jet Printing | Transactions | material bonded to metal |
| | Vest, R. W. | with | on Components, | through hetero atoms such as |
| | | MOD Inks | Hybrids and | O, N, S and P. Specifically, |
| | | for Hybrid | Manufacturing | silver neodecanoate and Au |
| | | Microcircuits | Technology, | amine 2-ethylhexoate is |
| | | | 12(4), 545-549, | exemlified. Dielectric ink |
| | | | 1987 | and resistance ink are mentioned |
| 2) | Lea | Direct-Write | 2000 Aug. 18 | (hfa)Ag(COD), (hfa)Cu(BTMS) |
| | Yancey | Metallizations | undergraduate | and(hfa)Cu(VTMS) are |
| | | with | thesis of | spayed or printed by inkjet |
| | | Organometallic | Berkely | printing on heated glass |
| | | Inks | University | annealed and resistance are |
| | | | | tested |
| 3) | C. Curtis, | Metallizations | To be presented | (hfa)Ag(COD) |
| | | by | at the NCPV | |
| | | Direct-Write | Program Review | |
| | | Inkjet Printing | Meeting Lakewood, | |
| | | | Colorado 14-17 | |
| | | | Oct. 2001 | |
| 4) | Alex | Synthesis of | Peer-Reviewed | SrCu2O2 from MOD(copper |
| | Martinson | Single | science | formate and strontium acetate) |
| | | Phase SrCu2O2 | Journal | is printed and annealed at |
| | | from Liquid | 2004 Mar. 3 | 770° C.used as photosemi- |
| | | Precursors | | conductor of solar cell |
| 5) | Kevin | Ink-Jet | Macromol. Rapid | Laminating polymer |
| | Cheng,* | Printing, | Commun. 2005, | electrolytes PAA and PAH by |
| | | Self-Assembled | 26, 247-264 | PEM technology and |
| | | Polyelectro- | | patterning the laminar with |
| | | lytes, and | | catalyst Na2PdCl4 and |
| | | Electroless | | depositing in copper bath |
| | | Plating: | | electrolessly. Lower metall- |
| | | | | ization is possible |

### DISCLOSURE OF INVENTION

### Technical Problem

The object of the present invention is to provide silver organo-sol ink for forming electrically conductive patterns with good physical properties.

Another object of the present invention is to provide silver organo-sol ink, which can be applied to traditional printing methods including inkjet-printing.

The other object of the present invention is to provide silver organo-sol ink, which can be reduced and metallized at a relatively lower temperature.

### Technical Solution

The present invention provides silver organo-sol ink of solution type for forming electrically conductive pattern comprising effective amount of silver C0 to C16 aliphatic carboxylate saturated or unsaturated, linear or branched, unsubstituted or substituted with amino, nitro and/or hydroxy group(s) having 1 to 3 carboxyl groups or silver aromatic carboxylate defined as Formulas 1; and organic solvent

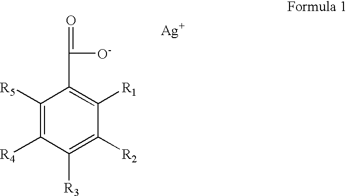

in which R₁, R₂, R₃, R₄ and R₅ are respectively COO⁻Ag⁺, H, OH, amino, nitro or C1 to C9 alkyl.

Herein, “organo-sol” means that silver exist as solution state bound to organic material. The silver carboxylate in the ink of the present invention acts as a precursor for forming metal silver by heat-treasting or reducing. The said organic solvent desirably consists of a reactive organic solvent, which can form chelate or complex with silver, and polar or nonpolar organic solvent for control of viscosity. The reactive organic solvents, which can form chelate or complex with silver, are, for example, organic solvents having keton, mercapto, carboxyl, aniline or sulfurous functional group, substituted or unsubstituted. The silver aliphatic carboxylate or silver aromatic carboxylate is typically 5˜70 wt % of the total ink composition.

As a preferred embodiment, the present invention provides silver organo-sol ink of solution type comprising 10 to 50 wt % of silver C0 to C16 aliphatic carboxylate saturated or unsaturated, linear or branched, unsubstituted or substituted with amino, nitro and/or hydroxy group(s) having 1 to 3 carboxyl groups; 10 to 60 wt % of reactive organic solvent selected from the group consisting of amine substituted by one or more C1 to C6 hydroxy alkyl and C1 to C16 aliphatic thiol, linear or branched; and residual polar or nonpolar organic solvent.

The silver C0 to C16 saturated or unsaturated aliphatic carboxylate is desirably saturated or has one or two double bonds. The silver aliphatic carboxylate, for example, silver malate, silver maleate, silver succinate, silver acetate, silver maloate, silver methacrylate, silver propionate, silver sorbate, silver citrate, silver undecylenate, silver neododecanate, silver oleate, silver oxalate, silver formate or silver gluconate

As another preferred embodiment, the present invention provides silver organo-sol ink of solution type comprising 10 to 50 wt % of silver aromatic carboxylate defined as Formulas 1a; 10 to 60 wt % of reactive organic solvent selected from the group consisting of amine substituted by one or more C1 to C6 hydroxy alkyl and C1 to C16 aliphatic thiol, linear or branched; and residual polar or nonpolar organic solvent

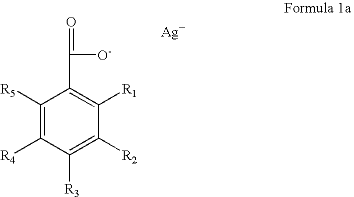

in which R₁, R₂, R₃, R₄ and R₅ are respectively H, OH, nitro or C1 to C9 alkyl.

Said silver aromatic carboxylate defined as Formulas 1a is, for example, silver benzoate or silver 4-aminobenzoate.

As another preferred embodiment, the present invention provides silver organo-sol ink of solution type comprising 10 to 50 wt % of silver aromatic carboxylate defined as Formulas 1b; 10 to 60 wt % of reactive organic solvent selected from the group consisting of amine substituted by one or more C1 to C6 hydroxy alkyl and C1 to C16 aliphatic thiol, linear or branched; and residual polar or nonpolar organic solvent

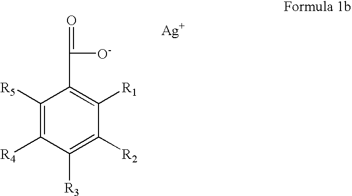

in which one among R₁, R₂, R₃, R₄ and R₅ is COO⁻Ag⁺ and the others are respectively H, OH, amino, nitro or C1 to C9 alkyl, but desirably R₃ is COO⁻Ag⁺ and the others are respectively H, OH, C1 to C9 alkyl.

Said silver aromatic carboxylate defined as Formulas 1b is, for example, silver phthalate. The silver aromatic carboxylate having two carboxyl groups has the merit of higher contents of silver.

As another preferred embodiment, the present invention provides silver organo-sol ink of solution type comprising 10 to 50 wt % of silver aromatic carboxylate defined as Formulas 1c; 10 to 60 wt % of reactive organic solvent selected from the group consisting of amine substituted by one or more C1 to C6 hydroxy alkyl and C1 to C16 aliphatic thiol, linear or branched; and residual polar or nonpolar organic solvent

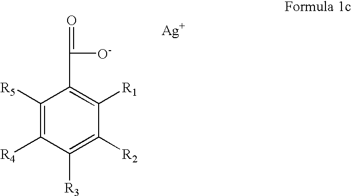

in which two or more among R₁, R₂, R₃, R₄ and R₅ are COO⁻Ag⁺, and the others are respectively H, OH or C1 to C9 alkyl, but desirably R₂ and R₄ are COO⁻Ag⁺.

Said silver aromatic carboxylate defined as Formulas 1c is, for example, silver trimesate. The silver aromatic carboxylate defined as Formulas 1c has higher in contents of silver than those defined as Formulas 1a and Formulas 1b.

The organo-sol ink of the present invention may further comprise surfactants and/or viscosity controlling agents. In addition, it may comprise further nonconductive polymeric or glassy material as matrix or flux material for silver conductor. The organo-sol ink of the present invention can be applied not only to processes for display manufacturing such as PDP and Rfid but also to other processes such as solar cells wherein conductive patterns are required.

Silver aromatic carboxylate defined as Formulas 1 has higher contents of silver, especially, silver benzoate has about 47 wt % of silver per mole of the compound. It has a merit of higher content of metallized silver even if small quantity is adopted. Silver aromatic carboxylate defined as Formulas 1 in the organo-sol ink of the present invention desirably ranges from 5 wt % to 70 wt % of the total ink composition since silver content becomes small below 5 w % and making solution with it becomes difficult above 70 wt %. The preferred range is 10 wt % to 50 wt %. The most preferred range is 20 wt % to 40 wt %. Silver aromatic carboxylate defined as Formulas 1 is prepared by reacting silver inorganic acid salt such as silver nitrate with alkali metal salt corresponding to Formulas 1 with silver replaced by alkali metal.

The said reactive organic solvent is broadly organic solvent which can form chelate or complex with silver through hetero atom N, O and S, more preferably, hydrocarbons having keton, mercapto, carboxyl, aniline or sulfurous functional group, substituted or unsubstituted. The most preferred are monoethanolamine, diethanolamine and tri-ethanolamine. The organo-sol ink of the present invention has light color but is basically clear. The viscosity of the initial solution which is prepared by dissolving the silver organic salt in a reactive organic solvent such as ethanolamine ranges about 10,000 to 100,000 cp, and thus it can be used in screen-printing, offset-printing and imprinting. It also can be diluted with diluent such as ethanol or water according to the object of use.

Silver organo-sol prepared by dissolving silver aromatic carboxylate in reactive solvent, for example, amine substituted by one or more ethanol may be further diluted with ethylene glycol or water to be deposited on a hydrophilic substrate. On the other hand, it may be diluted with an alcohol of short chain alcohol such as ethanol to be deposited on a substrate having a hydrophobic metal oxide film thereon. It is presumed that the solubility increases drastically because the reactive organic solvent forms complex with the silver aromatic carboxylate by chelating or coordinate covalent bonding.

A preferred nonpolar organic solvent is an aliphatic or aromatic hydrocarbon or mixture thereof. A preferred polar organic solvent is water or C1 to C12, saturated or unsaturated, mono to tri functional aliphatic alcohol. The organic solvent, for example, is 2-methoxy ethanol, 1,2-hexanediol, benzene, toluene, xylene, dimethylcarbithol, kerosene ethanol, methanol, 2-propanol, chloroform or ethylene glycol.

### ADVANTAGEOUS EFFECTS

By the present invention, silver organo-sol ink of solution type basically having higher content of silver is obtained. The solution type ink of the present invention can be used for forming conductive patterns in flat panel display such as plasma display panel(PDP) to reduce the numbers of steps for pattern forming. Some of the solution type ink of the present invention can be used for forming conductive patterns on a milder substrate such as thermoset plastic at a lower reducing temperature.

### BRIEF DESCRIPTION OF THE DRAWINGS

FIG. 1 through FIG. 3 show FT-IR spectrometer graphs of synthesized organo-silver precursors prepared in Examples 1 through 19 except Examples 12.

FIG. 4 through FIG. 7 are TGA graphs of synthesized organo-silver precursors prepared in Examples 1 through 19.

FIG. 8 through 10 show SEM images (1000 times enlarged) of a sample prepared in Examples 1 through 19 except Example 16 after heat-treatment at respective reducing temperatures for 10 minutes.

FIG. 11 shows microscopic images of calcined patterns on glass panels using organosol ink prepared by Example 1.

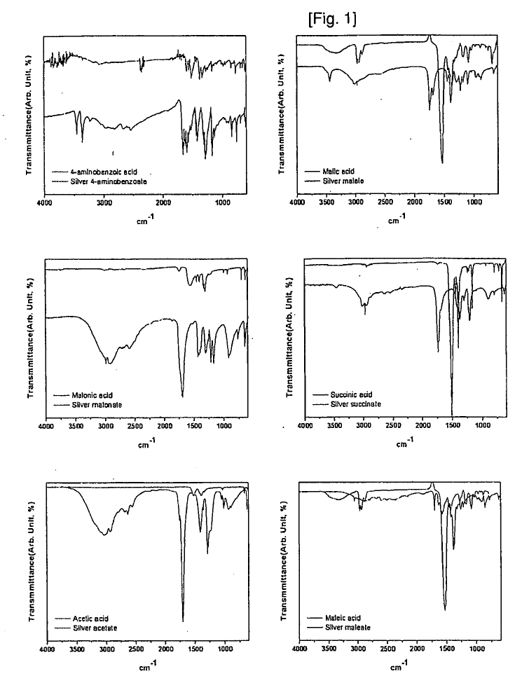

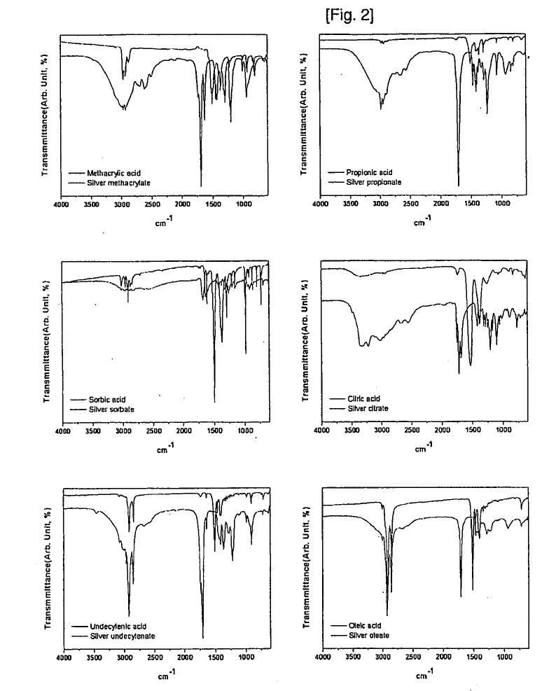

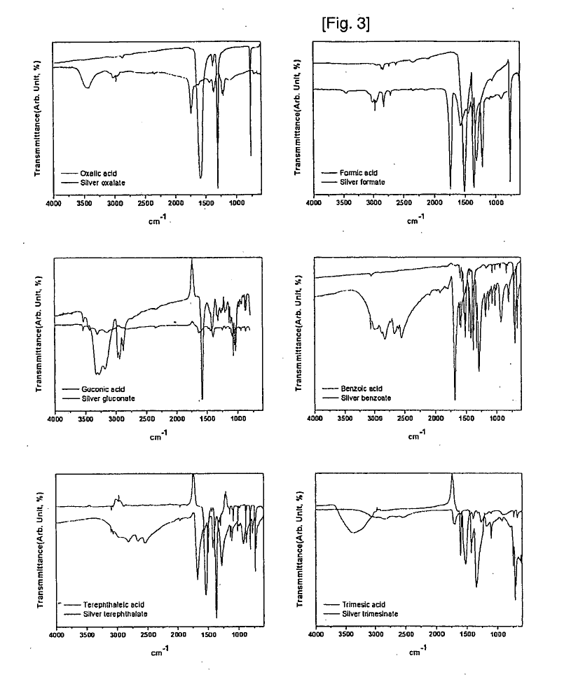

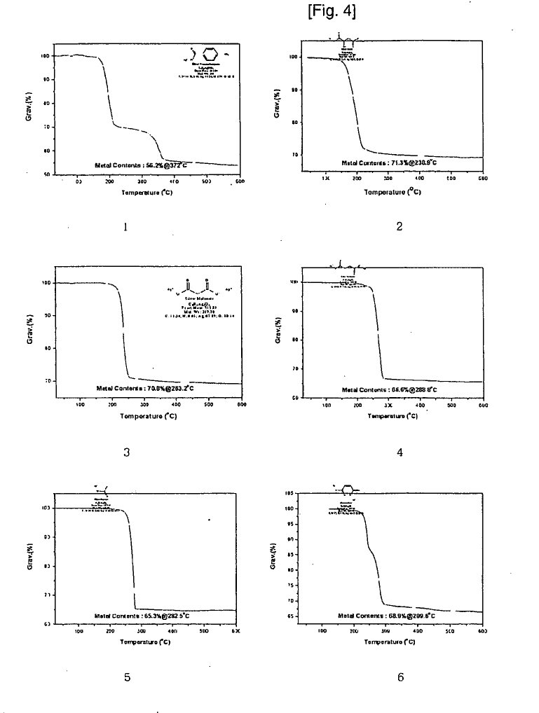

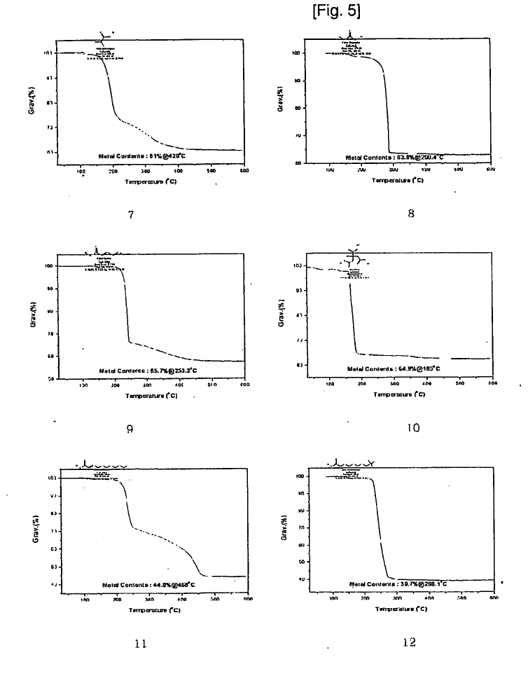

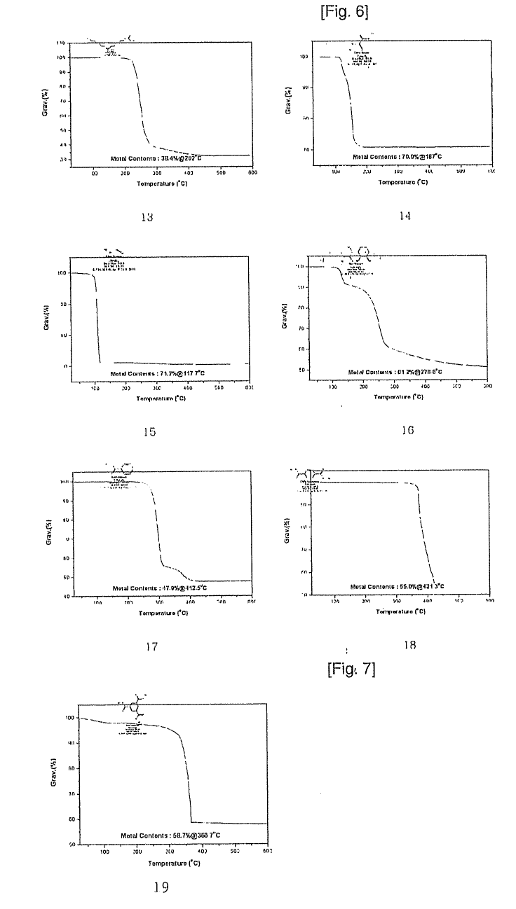

### BEST MODE FOR CARRYING OUT THE INVENTION

The present invention is illustrated by examples below. However, such examples presented for the purpose of illustration do not serve as a basis to decide the scope of the invention.

### Example 1

50 mmol 4-aminobenzoic acid is dissolved in 50 ml, of methanol. 50 mmol NaOH dissolved in 50 ml water is added slowly to the 4-aminobenzoic acid solution prepared while stirring to obtain sodium 4-aminobenzoate emulsion. 50 mmol silver nitrate dissolved in 50 ml water is added to the sodium 4-aminobenzoate emulsion controlled at −5° C., and then white precipitate forms fast. The precipitate is washed to remove unreacted silver nitrate and NaOH with water, filtered and washed several times to remove unreacted 4-aminobenzoic acid with methanol. The filtrant is dried at room temperature to finally prepare silver 4-aminobenzoate. Silver content was measured by the characteristic peak of TGA graph (TA instrument, SDT Q600). Also with FT-IR (Perkin Elmer, Spectrum GX), the reaction process for forming silver 4-aminobenzoate was confirmed by observing that the peak characteristic of C═O bond is shifted from 1700 cm⁻¹ to around 1500 cm⁻¹ and the broad peaks between 3500˜4000 cm⁻¹ characteristic for hydroxyl group in —COOH. disappear. The shift is presumably caused by resonance effect of carboxyl group. The yield of silver carboxylate powder is 93%.

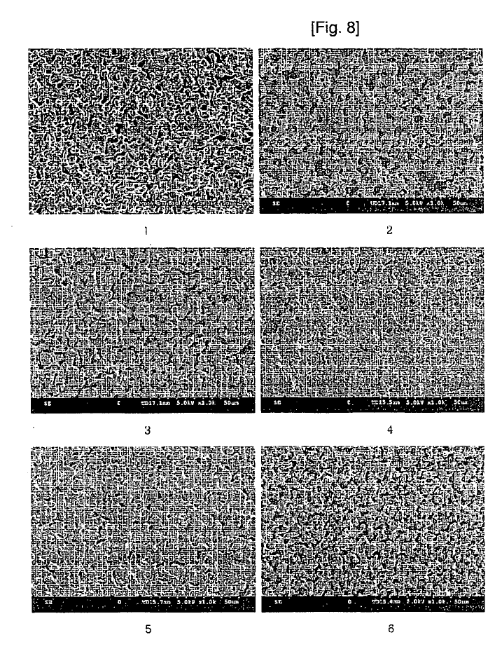

0.1 mol prepared powder of silver 4-aminobenzoate is dissolved in 0.12 mol triethanol amine and ethanol is added and stirred for 30 minutes to control viscosity 10 cPs at 25° C. 1 g of such prepared organo-sol ink is coated on a glass substrate with a bar coater, dried at room temperature and then heat-treated for 10 minutes at 372° C. The final silver content is decided by the weights of the solution coated and residual solid after heat-treatment. The facial resistance is measured with 4-probe device. The micro-structure of the silver layer was analyzed with SEM (Hitachi, S-4300). The image is shown in FIG. 8. Amounts of reagents and measured values are listed in table 3.

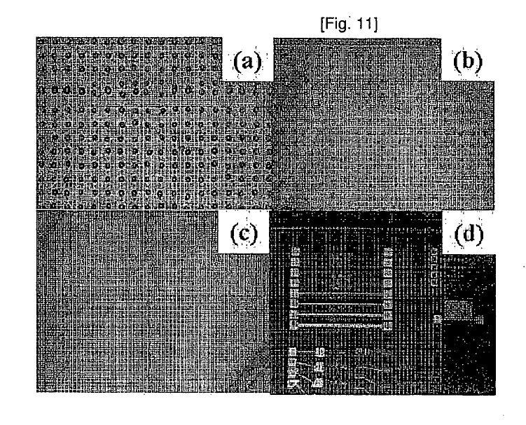

By using SE-128 head with a inkjet printer made by Litrex Corp, (a) 72.2 μm dots are drawn on glass panels. By using SX-128 head with the same inkjet printer (b) 56 μm dots, (c) a 60 μm line and (d) more complex circuit patterns are drawn on glass panels respectively. Nozzle head conditions of drawing are under −20 mmHg pressure of meniscus and under 1.2 kHz frequency, 119.5V applied and working time 9.8 μs of piezo. Drawing speeds are 20 mm/sec. The panels are dried at room temperature and then heat-treated for 10 minutes at 372° C. Calcined pattern microscopic images are shown FIG. 11.

### Example 2

Example 2 is carried out the same way as Example 1 except that malic acid is used instead of 4-aminobenzoic acid. The yield of the silver carboxylate powder is 93%.

An image of the micro-structure of the silver layer analyzed with SEM is shown in FIG. 8. Amounts of reagents and measured values are listed in table 3.

### Example 3

Example 3 is carried out the same way as Example 1 except that maleic acid is used instead of 4-aminobenzoic acid. The yield of the silver carboxylate powder is 89%.

An image of the micro-structure of the silver layer analyzed with SEM is shown in FIG. 8. Amounts of reagents and measured values are listed in table 3.

### Example 4

Example 4 is carried out the same way as Example 1 except that succinic acid is used instead of 4-aminobenzoic acid. The yield of the silver carboxylate powder is 46.5%.

An image of the micro-structure of the silver layer analyzed with SEM is shown in FIG. 8. Amounts of reagents and measured values are listed in table 3.

### Example 5

Example 5 is carried out the same way as Example 1 except that acetic acid is used instead of 4-aminobenzoic acid. The yield of the silver carboxylate powder is 87.7%.

An image of the micro-structure of the silver layer analyzed with SEM is shown in FIG. 8. Amounts of reagents and measured values are listed in table 3.

### Example 6

Example 6 is carried out the same way as Example 1 except that malonic acid is used instead of 4-aminobenzoic acid. The yield of the silver carboxylate powder is 87.5%.

An image of the micro-structure of the silver layer analyzed with SEM is shown in FIG. 8. Amounts of reagents and measured values are listed in table 3.

### Example 7

Example 7 is carried out the same way as Example 1 except that methacrylic acid is used instead of 4-aminobenzoic acid. The yield of the silver carboxylate powder is 74.3%.

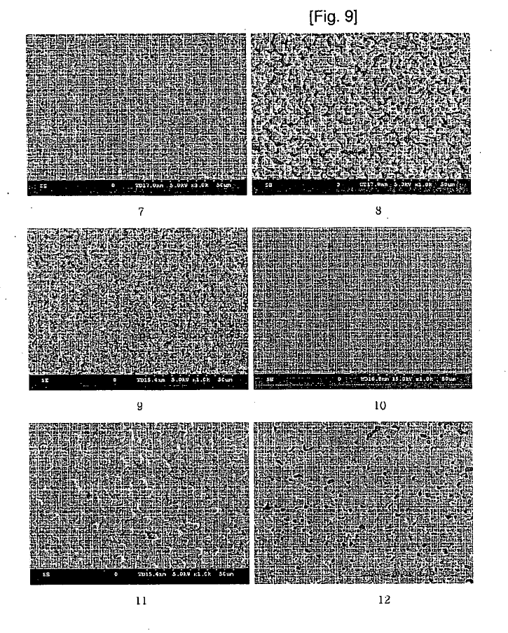

An image of the micro-structure of the silver layer analyzed with SEM is shown in FIG. 9. Amounts of reagents and measured values are listed in table 3.

### Example 8

Example 8 is carried out the same way as Example 1 except that propionic acid is used instead of 4-aminobenzoic acid. The yield of the silver carboxylate powder is 63%.

An image of the micro-structure of the silver layer analyzed with SEM is shown in FIG. 9. Amounts of reagents and measured values are listed in table 3.

### Example 9

Example 9 is carried out the same way as Example 1 except that sorbic acid is used instead of 4-aminobenzoic acid. The yield of the silver carboxylate powder is 82%.

An image of the micro-structure of the silver layer analyzed with SEM is shown in FIG. 9. Amounts of reagents and measured values are listed in table 3.

### Example 10

Example 10 is carried out the same way as Example 1 except that citric acid is used instead of 4-aminobenzoic acid. The yield of the silver carboxylate powder is 88%.

An image of the micro-structure of the silver layer analyzed with SEM is shown in FIG. 9. Amounts of reagents and measured values are listed in table 3.

### Example 11

Example 11 is carried out the same way as Example 1 except that (E)-undec-2-enoic acid is used instead of 4-aminobenzoic acid. The yield of the silver carboxylate powder is 93%.

An image of the micro-structure of the silver layer analyzed with SFM is shown in FIG. 9. Amounts of reagents and measured values are listed in table 3.

### Example 12

Example 12 is carried out the same way as Example 1 except that neododecanoic acid is used instead of 4-aminobenzoic acid. The yield of the silver carboxylate powder is 98%.

An image of the micro-structure of the silver layer analyzed with SEM is shown in FIG. 9. Amounts of reagents and measured values are listed in table 3.

### Example 13

Example 13 is carried out the same way as Example 1 except that oleic acid is used instead of 4-aminobenzoic acid. The yield of the silver carboxylate powder is 95.3%.

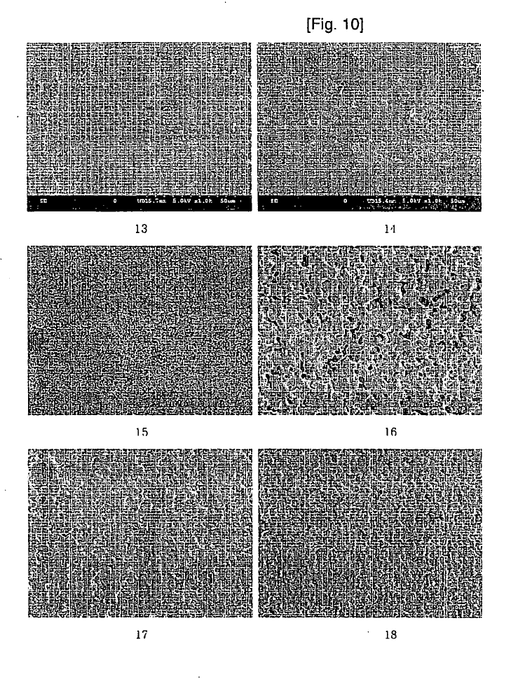

An image of the micro-structure of the silver layer analyzed with SEM is shown in FIG. 10. Amounts of reagents and measured values are listed in table 3.

### Example 14

Example 14 is carried out the same way as Example 1 except that oxalic acid is used instead of 4-aminobenzoic acid. The yield of the silver carboxylate powder is 96%.

An image of the micro-structure of the silver layer analyzed with SEM is shown in FIG. 10. Amounts of reagents and measured values are listed in table 3.

### Example 15

Example 15 is carried out the same way as Example 1 except that formic acid is used instead of 4-aminobenzoic acid and the sodium formate emulsion is controlled at −15° C. while silver nitrate dissolved in 50 mL water is added. The yield of the silver carboxylate powder is 77%.

An image of the micro-structure of the silver layer analyzed with SEM is shown in FIG. 10. Amounts of reagents and measured values are listed in table 3.

### Example 16

Example 16 is carried out the same way as Example 1 except that gluconic acid is used instead of 4-aminobenzoic acid. The yield of the silver carboxylate powder is 80%.

An image of the micro-structure of the silver layer analyzed with SEM is shown in FIG. 10. Amounts of reagents and measured values are listed in table 3.

### Example 17

Example 17 is carried out the same way as Example 1 except that benzoic acid is used instead of 4-aminobenzoic acid. The yield of the silver carboxylate powder is 87.7%.

An image of the micro-structure of the silver layer analyzed with SEM is shown in FIG. 10. Amounts of reagents and measured values are listed in table 3.

### Example 18

Example 18 is carried out the same way as Example 1 except that terephthalic acid is used instead of 4-aminobenzoic acid. The yield of the silver carboxylate powder is 98%.

An image of the micro-structure of the silver layer analyzed with SEM is shown in FIG. 10. Amounts of reagents and measured values are listed in table 3.

### Example 19

Example 19 is carried out the same way as Example 1 except that trimesic acid is used instead of 4-aminobenzoic acid. The yield of the silver carboxylate powder is 87.7%.

Amounts of reagents and measured values are listed in table 3.

TABLE 3
physical properties of silver precursors. silver inks. and silver films.

| | | reducing | silver content in | | solid content in | | facial |
|---|---|---|---|---|---|---|---|
| | | temperature | precursor (wt. %) | | ink (wt. %) | | resistance |
| Example No.; Precursors | | ° C. | theoretical | measured by TGA | calaulated | measured | (Ω) |
| 1 | Silver | 372.0 | 44.21 | 56.2 | 20 | 21 | 0.7609 |
| | 4-aminobenzoate | | | | | | |
| 2 | Silver malate | 238.9 | 62.03 | 71.3 | 28 | 27 | 0.7588 |
| 3 | Silver malonate | 263.2 | 67.89 | 70.8 | 26 | 27 | 0.7555 |
| 4 | Silver succinate | 288.8 | 65.02 | 66.6 | 30 | 25 | 0.7390 |
| 5 | Silver acetate | 282.5 | 64.63 | 65.3 | 30 | 28 | 0.7436 |
| 6 | Silver maleate | 299.6 | 65.42 | 68.9 | 28 | 27 | 0.7632 |
| 7 | Silver methacrylate | 429.0 | 55.90 | 61.0 | 20 | 22 | 0.7556 |
| 8 | Silver propionate | 290.4 | 59.62 | 63.8 | 27 | 23 | 0.7436 |
| 9 | Silver sorbate | 253.2 | 49.26 | 65.7 | 22 | 19 | 0.7890 |
| 10 | Silver citrate | 185.0 | 63.12 | 64.9 | 24 | 16 | 0.7639 |
| 11 | Silver Undecylenate | 466.0 | 37.05 | 44.8 | 21 | 19 | 0.7653 |
| 12 | Silver | 298.1 | 35.12 | 39.7 | 38 | 33 | 0.7659 |
| | neododecanate | | | | | | |
| 13 | Silver oleate | 292.0 | 27.71 | 38.4 | 17 | 11 | 0.9372 |
| 14 | Silver oxalate | 187.0 | 71.02 | 70.9 | 29 | 22 | 0.7746 |
| 15 | Silver formate | 117.7 | 70.55 | 71.2 | 40 | 33 | 0.8012 |
| 16 | Silver gluconate | 278.8 | 35.60 | 61.2 | 23 | 19 | 0.8003 |
| 17 | Silver benzoate | 412.5 | 47.11 | 47.9 | 28 | 25 | 0.7437 |
| 18 | Silver terephthalate | 421.3 | 56.79 | 55.0 | 33 | 30 | 0.7553 |
| 19 | Silver trimesinate | 366.7 | 60.97 | 58.7 | 38 | 31 | 0.7399 |

### INDUSTRIAL APPLICABILITY

The solution type ink of the present invention can be used for forming conductive patterns by traditional printing technology, especially by inkjet-printing, in flat panel display such as plasma display panel(PDP) to reduce the numbers of steps for pattern forming.

1. Silver organo-sol ink of solution type for forming electrically conductive pattern comprising effective amount of silver C0 to C16 aliphatic carboxylate saturated or unsaturated, linear or branched, unsubstituted or substituted with amino, nitro and/or hydroxy group(s) having 1 to 3 carboxyl groups or silver aromatic carboxylate defined as Formulas 1; and organic solvent 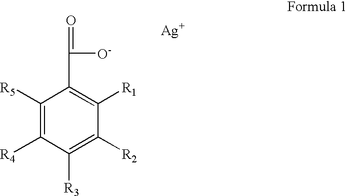
in which R₁, R₂, R₃, R₄ and R₅ are respectively COO⁻Ag⁺, H, OH, amino, nitro or C1 to C9 alkyl.

2. Silver organo-sol ink of solution type according to claim 1, wherein said organic solvent consists of a reactive organic solvent which can form chelate or complex with silver and polar or nonpolar organic solvent for control of viscosity.

3. Silver organo-sol ink of solution type according to claim 2, wherein said reactive organic solvent is a hydrocarbon having keton, mercapto, carboxyl, aniline or sulfurous functional group.

4. Silver organo-sol ink of solution type according to claim 3, wherein said nonpolar organic solvent is an aliphatic or aromatic hydrocarbon and said polar organic solvent is water or C1 to C12, saturated or unsaturated, mono to tri functional aliphatic alcohol.

5. Silver organo-sol ink of solution type according to claim 4, wherein said silver aromatic carboxylate is 5 to 70 wt % of the total silver organo-sol ink.

6. Silver organo-sol ink of solution type according to claim 2, wherein said ink is comprising 10 to 50 wt % of silver aromatic carboxylate defined as Formulas 1a; 10 to 60 wt % of reactive organic solvent selected from the group consisting of amine substituted by one or more C1 to C6 hydroxy alkyl and C1 to C16 aliphatic thiol, linear or branched; and residual polar or nonpolar organic solvent 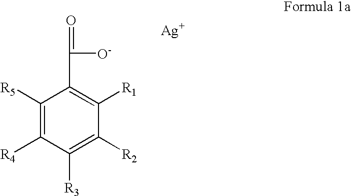
in which R₁, R₂, R₃, R₄ and R₅ are respectively H, OH, nitro or C1 to C9 alkyl.

7. Silver organo-sol ink of solution type according to claim 6, wherein said silver aromatic carboxylate defined as Formulas 1a is silver benzoate or silver 4-aminobenzoate.

8. Silver organo-sol ink of solution type according to claim 2, wherein said ink is comprising 10 to 50 wt % of silver aromatic carboxylate defined as Formulas 1b; 10 to 60 wt % of reactive organic solvent selected from the group consisting of amine substituted by one or more C1 to C6 hydroxy alkyl and C1 to C16 aliphatic thiol, linear or branched; and residual polar or nonpolar organic solvent 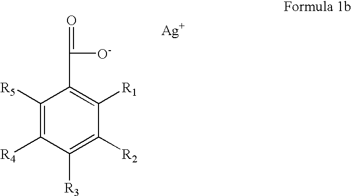
in which one among R₁, R₂, R₃, R₄ and R₅ is COO⁻Ag⁺, and the others are respectively H, OH, amino, nitro or C1 to C9 alkyl.

9. Silver organo-sol ink of solution type according to claim 8, wherein R₃ is COO⁻Ag⁺ and R₁, R₂, R₄ and R₅ are respectively H, OH or C1 to C9 alkyl.

10. Silver organo-sol ink of solution type according to claim 9, wherein said silver aromatic carboxylate defined as Formulas 1b is silver phthalate.

11. Silver organo-sol ink of solution type according to claim 2, wherein said ink is comprising 10 to 50 wt % of silver aromatic carboxylate defined as Formulas 1c; 10 to 60 wt % of reactive organic solvent selected from the group consisting of amine substituted by one or more C1 to C6 hydroxy alkyl and C1 to C16 aliphatic thiol, linear or branched; and residual polar or nonpolar organic solvent 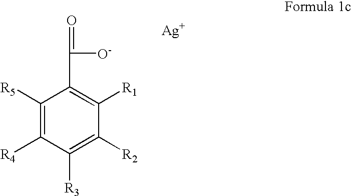
in which two or more among R₁, R₂, R₃, R₄ and R₅ are COO⁻Ag⁺, and the others are respectively H, OH or C1 to C9 alkyl.

12. Silver organo-sol ink of solution type according to claim 11, wherein R₂ and R₄ are COO⁻Ag⁺ and R₁, R₃ and R₅ are respectively H, OH or C1 to C9 alkyl.

13. Silver organo-sol ink of solution type according to claim 12, wherein said silver aromatic carboxylate defined as Formulas 1c is silver trimesate.

14. Silver organo-sol ink of solution type according to any one of claim 1 to claim 13, wherein said silver organo-sol ink is used for electrically conductive patterns by inkjet-printing.

15. Silver organo-sol ink of solution type according to claim 14, wherein said silver aromatic carboxylate is 20 to 40 wt % of the total silver organo-sol ink.

16. Silver organo-sol ink of solution type according to claim 15, wherein said reactive solvent is ethanolamine, diethanolamine or triethanolamine.

17. Silver organo-sol ink of solution type according to claim 1, wherein said ink is comprising effective amount of silver C0 to C8 aliphatic carboxylate saturated or unsaturated, linear or branched, unsubstituted or substituted with amino, nitro and/or hydroxy group(s).

18. Silver organo-sol ink of solution type according to claim 17, wherein said aliphatic carboxylate is having 1 to 3 carboxyl groups.

19. Silver organo-sol ink of solution type according to claim 18, wherein said ink is comprising 10 to 50 wt % of said silver aliphatic carboxylate; 10 to 60 wt % of reactive organic solvent selected from the group consisting of amine substituted by one or more C1 to C6 hydroxy alkyl and C1 to C16 aliphatic thiol, linear or branched; and residual polar or nonpolar organic solvent

20. Silver organo-sol ink of solution type according to claim 19, wherein said silver aliphatic carboxylate is silver citrate, silver oxalate or silver formate.
